(19) United States
(12) Patent Application Publication
(10) Pub. No.: US 2004/0125544 A1
(43) Pub. Date: Jul. 1, 2004

(54) Solid electrolyte and capacitor element using the same

(75) Inventors: Masashi Ohata, Neyagawa-city (JP); Akira Matsumura, Hirakata-city (JP)

Correspondence Address: Law Offices of Townsend & Banta, South Building, Suite 900, 601 Pennsylvania Avenue, N.W., Washington, DC, 20004, US

(73) Assignee: NIPPON PAINT CO., LTD.

(21) Appl. No.: 10/733,265

(22) Filed: Dec. 12, 2003

(30) Foreign Application Priority Data
Dec. 18, 2002 (JP) 2002-367024

(51) Int. Cl. H01G 9/00

(52) U.S. Cl. 361/523

(57) ABSTRACT

The solid electrolyte, wherein the solid electrolyte is formed by making a thin film containing at least one of a polysilane which is soluble in organic solvent and a silicone compound, to contain a metal salt compound such as LiBF₄, wherein the silicone compound is represented by the following general formula (1)

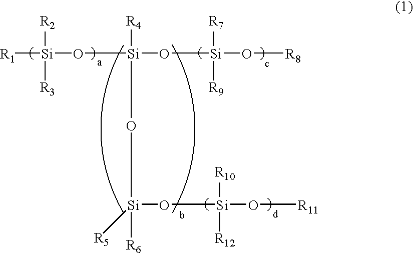

and by baking this thin film at a temperature of, for example, 400° C. or higher (wherein R₁ to R₁₂ are groups selected from the group consisting of aliphatic hydrocarbon groups containing 1 to 10 carbon atoms, for a part of which a halogen group or a glycidyloxy group may substitutes, aromatic hydrocarbon groups containing 6 to 12 carbon atoms and alkoxy groups containing 1 to 8 carbon atoms and may be identical with or different from one another, and a, b, c and d are integers including 0 and satisfy a relationship of a+b+c+d≧1).

### BACKGROUND OF THE INVENTION

1. Field of the Invention

The present invention relates to a solid electrolyte which can be used to any solid-state capacitor element.

2. Description of the Related Art

Silicon compounds, having Si—Si bonds as a skeleton, such as polysilanes are used in photoresists and color filters by utilizing a photodegradable property thereof. For example, it was proposed a method of producing a color film comprising the steps of forming a latent image of a colored pattern in an exposed area by selectively exposing a thin film consisting of a photosensitive resin composition containing a polysilane having a specific structure and a cyclic silane and coloring the exposed area where the latent image of the colored pattern is formed with a colorant solution containing dyes or pigments compound having a specific structure (Japanese Patent Laid-Open No.2001-281436). And, it was proposed that a polysilane is used as an optical reflector with a diffusion plate (Japanese Patent Laid-Open No.2001-281421).

On the other hand, in a capacitor element such as a battery and a capacitor, it is studied to make the capacitor element complete solid-state by using the solid electrolyte formed by dispersing alkali metal salts such as lithium sulfate, lithium perchlorate and the like in a polar polymer such as polyethylene oxide.

### SUMMARY OF THE INVENTION

It is an object of the present invention to provide a novel solid electrolyte and a capacitor element using the same.

The solid electrolyte of the present invention is characterized in that the solid electrolyte is formed by baking a thin film in which a silicon compound contains a metal salt compound.

The silicon compounds according to the present invention include a substance containing at least one of a polysilane which is soluble in organic solvent and a silicone compound. Preferably, it may be a substance containing both of a polysilane and a silicone compound.

Hereinafter, polysilanes and silicone compounds will be described.

<Polysilane>

The polysilane used in the present invention is not specifically limited as long as it is a strait-chain, cyclic or branched silane compound having a Si—Si bond. Also, compounds generally referred to as polysiline are included.

Here, the polysilane is at least one kind of polymer selected from the group consisting of:

(i) strait-chain polysilanes and cyclic polysilanes, in which a main skeleton structure in chemical structures is represented by the general formula

(R¹₂Si)ₘ (3)

wherein R¹s are identical with or different from one another and represent a hydrogen atom, an alkyl group, an alkenyl group, an aryl alkyl group, an aryl group, an alkoxy group, a hydroxyl group, a hydroxyl-containing phenyl group, an amino group or a silyl group, and m is an integer ranging from 2 to 10000;

(ii) silicon network polymers, in which a principal skeleton structure is represented by the general formula

(R²Si)ₙ (4)

wherein R²s are identical with or different from one another and represent a hydrogen atom, an alkyl group, an alkenyl group, an aryl alkyl group, an aryl group, an alkoxy group, a hydroxyl group, a hydroxyl-containing phenyl group, an amino group or a silyl group, and n is an integer ranging from 4 to 10000; and

(iii) silicon network polymers, in which a principal skeleton structure is represented by the general formula

(R³₂Si)ₓ(R³Si)_{y}Siₓ (5)

wherein R³s represent a hydrogen atom, an alkyl group, an alkenyl group, an aryl alkyl group, an aryl group, an alkoxy group, a hydroxyl group, a hydroxyl-containing phenyl group, an amino group or a silyl group and all of R³s may be identical or two or more of R³s may be different, and the sum of x, y and z ranges from 5 to 10000.

In the polysilanes represented by the above-mentioned general formulas (3), (4), and (5), alkyl portions of the alkyl group and the aryl alkyl group, and an alkyl portion of the alkoxy group may be strait-chain, cyclic or branched aliphatic hydrocarbon groups containing 1 to 14 carbon atoms, preferably 1 to 10 carbon atoms, and more preferably 1 to 6 carbon atoms. The alkenyl group may be a univalent strait-chain, cyclic or branched aliphatic hydrocarbon groups having at least one carbon-to-carbon double bond, containing 1 to 14 carbon atoms, preferably 1 to 10 carbon atoms, and more preferably 1 to 6 carbon atoms. Aryl portions of the aryl group and the aryl alkyl group may be aromatic hydrocarbon groups which may have at least one substitution group and preferably, a phenyl group or a naphthyl group which may have at least one substitution. Though a substitution group for aryl portions of the aryl group and the aryl alkyl group is not specifically limited, at least one kind selected from the group consisting of an alkyl group, an alkoxy group, a hydroxyl group and an amino group is preferred.

The polysilane used in the present invention may have at least one hydroxyl group combined directly with a silicon atom (a silanol group). The polysilane used in the present invention may have one or more hydroxyl group combined directly with a silicon atom on average per a molecule. Usually, the polysilane contains about from 0.01 to 3 on average of hydroxyl groups per one silicon atom, and preferably, contains from 0.1 to 2.5, more preferably about from 0.2 to 2, particularly preferably about from 0.3 to 1.5 of hydroxyl groups.

And, the introducing the hydroxyl group in the polysilane can be effected by publicly known methods. For example, in a method of condensation polymerizing halosilanes while dehalogenation, the hydroxyl group can be easily introduced by adding water at the time of completion of condensation polymerization.

And, as the polysilane, the silicon network polymer, having a network structure, are preferably used.

Further, as the polysilane, a polysilane in network form shown in Japanese Patent Laid-Open No.2001-48987 can be used. That is, the polysilane in network form, which is formed by allowing magnesium or magnesium alloy to act on trihalosilane in the co-presence of lithium salt and metal halide in a non-proton solvent can be used.

As the polysilane used in the present invention, a polysilane having a weight-average molecular weight of 1000 or higher is preferred. When the weight-average molecular weight is less than 1000, film properties such as chemical resistance and heat resistance may be inadequate. The weight-average molecular weight is more preferably in a range from 1000 to 10000, furthermore preferably from 1000 to 20000.

<Silicone compound>

The silicone compound used in the present invention may be a substance represented by the following formula:

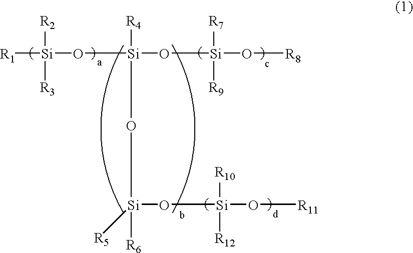

wherein R₁ to R₁₂ are groups selected from the group consisting of aliphatic hydrocarbon groups containing 1 to 10 carbon atoms, for a part of which a halogen group or a glycidyloxy group may substitutes, aromatic hydrocarbon groups containing 6 to 12 carbon atoms and alkoxy groups containing 1 to 8 carbon atoms and may be identical with or different from one another, and a, b, c and d are integers including 0 and satisfy a relationship of a+b+c+d≧1.

The specific example of the aliphatic hydrocarbon group contained in this silicone compound may be chain groups such as a methyl group, a propyl group, a butyl group, a hexyl group, an octyl group, a decyl group, a trifluoropropyl group, a glycidyloxypropyl group and the like; and alicyclic groups such as a cyclohexyl group and a methylcyclohexyl group. The specific example of the aromatic hydrocarbon group may be a phenyl group, a p-tolyl group, a biphenyl group and the like. The specific example of the alkoxy group may be a methoxy group, ethoxy group, a phenoxy group, an octyloxy group, a t-butoxy group and the like.

Kinds of the above groups of R₁ to R₁₂ and values of the above a, b, c and d is not particularly important and is not specifically limited as long as these are compatible with the polysilane and the organic solvent and the films are transparent. If compatibility is considered, the silicone compound having the same hydrocarbon group as that of polysilane to be used is preferred. For example, when phenylmethylic polysilane is used as a polysilane, it is preferred to use the same phenylmethylic or diphenylic silicone compound. And, a silicone compound, which has two or more alkoxy groups in a molecule as at least two of groups of R₁ to R₁₂ are alkoxy groups containing 1 to 8 carbon atoms, can be utilized as a crosslinking agent. Methylphenylmethoxysilicone and phenylmethoxysilicone including alkoxy groups in an amount from 15 to 35% by weight can be used as a crosslinking agent.

Preferably, the ratio between the polysilane and the silicone compound in the silicon compound is in a range from 1:99 to 99:1 by weight.

The silicon compound may further contains at least either of peroxides or benzophenon derivatives. Preferably, a substance having a benzophenon skeleton represented by the following formula (2) may be used as the benzophenon derivative. And, a substance having at least a bond represented by —C (═O)—O—O— in a molecular structure may preferably be used as the peroxide:

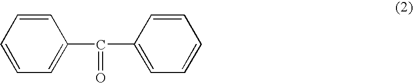

The content of the peroxide in the silicon compound is preferably in a range from 1 to 49% by weight. And, the content of the benzophenon derivative is preferably in a range from 1 to 49% by weight. Incidentally, any content described above means a content in a thin film antecedent to baking.

<Metal salt compound>

The silicon compound film of the present invention further contains a metal salt compound. The content of the metal salt compound is preferable in a range of 0.1 to 49% by weight in the thin film antecedent to baking. When the content of the metal salt compound is less than this range, conductivity becomes low and sufficient characteristics as an electrolyte may not be achieved. When the content of the metal salt compound becomes too much, the form of a thin film cannot be maintained and the thin film may not be used as an solid electrolyte.

The metal salt compound may be lithium salt compound, sodium salt compound, silver salt compound and potassium salt compound.

The specific example of the lithium salt may be LiBF₄, LiClO₄, LiPF₆, LiAsF₆, LiCF₃SO₃, LiN(CF₃SO₂)₂, LiC(CF₃SO₂)₃, LiSCN, LiI, LiNO₃, LiCl, LiBr and the like.

The silicon compound film of the present invention can be formed by dissolving the above-mentioned polysilane and/or silicone compound, the benzophenon derivative and/or peroxide as required and further the above-mentioned metal salt compound in the organic solvent, and applying and then drying this dissolved solution. After the silicon compound film is formed, this film is baked at a designated temperature. A baking temperature is preferably 400° C. or higher. And, an upper limit of the baking temperature is preferably 1500° C. or lower. The baking time preferably ranges between 30 seconds to 48 hours.

Further, pre-baking may be previously performed before the above baking. A pre-baking temperature is preferable about 50 to 399° C. The pre-baking time preferably ranges between 10 seconds to 48 hours.

The capacitor element of the present invention is characterized by having a structure in which the above-mentioned solid electrolyte of the present invention is sandwiched between a pair of electrodes. As the electrode, metals, metal oxides or conductive organic compounds and the like can be used. A material combining two or more of these materials may also be used.

As the electrode, metal such as lithium, calcium, magnesium, aluminum, zinc, yttrium, iridium, indium, cadmium, gadolinium, gallium, gold, silver, chromium, silicon, germanium, cobalt, samarium, zirconium, tin, strontium, cesium, cerium, selenium, tungsten, carbon, tantalum, titanium, iron, tellurium, copper, lead, niobium, nickel, platinum, vanadium and palladium can be used. Also, an alloy of two or more of these metals may be used. Further, with respect to the metal oxide, the respective oxides of the above-mentioned metals or alloys may be used.

As the conductive organic compound, conductive polymers such as polyacetylene, polythiophene, polyparaphenylenevinylene, polypyrrole, polyparaphenylene, polyacene, polythiazyl, polyparaphenylene sulfide, poly(2,5-thienylene vinylene) and polyfluorene, or derivatives thereof; or aromatic amine derivatives or multimer thereof can be used. These conductive organic compounds can be used alone or in combination with a doping agent such as iodine.

The above-mentioned electrode can be prepared by using known wet methods of film formation such as a spin coating technique, a dipping technique, a screen printing technique and the like or known dry methods of film formation such as a vacuum evaporation technique and a sputtering technique.

Particularly, as the electrode material, a chromium compound formed from metallic chromium by heat treatment conducted upon baking the silicon compound film is preferred.

The capacitor element according to the present invention can be charged by applying a predetermined voltage or current between a pair of electrodes and after charging, it acts as a power source when a charger is removed and a closed circuit via a load is composed.

### BRIEF DESCRIPTION OF THE DRAWINGS

FIG. 1(a) shows the complex impedance plots of a solid electrolyte of the present invention prepared in Example and FIG. 1(b) is an enlarged view thereof.

### DESCRIPTION OF THE PREFERRED EXAMPLE

Hereinafter, the present invention will be described in detail by way of examples, but the present invention is not limited to this example.

### EXAMPLE 1

2 parts by weight of polymethylphenylsilane, 1 part by weight of a silicone compound (“TSR-165” produced by GE Toshiba Silicones Co.,Ltd.), 0.3 parts by weight of BTTB (3,3′,4,4′-tetra-(t-butylperoxycarbonyl)benzophenon) and LiBF₄ were dissolved in anisole (solvent) in a dark place to prepare a silicon compound solution. Here, LiBF₄ was added so as to be 11 parts by weight per 100 parts by weight of polymethylphenylsilane.

The resulting silicon compound solution was applied to a glass substrate 3 cm square, onto one side of which chromium had been evaporated so as to be 20 nm in film thickness to form a chromium electrode, using a spin coating technique, and then dried at 120° C. for 10 minutes in an oven, and then prebaked at 200° C. for 30 minutes on a hot plate.

Next, the silicon compound film was baked at 550° C. for 30 minutes in an oven. The film thickness after baking was 0.4 μm.

By vacuum evaporating aluminum onto the post-baking thin film, a capacitor element of a sandwich type consisting of chromium/a baked silicon compound film/aluminum was prepared. The area of the electrode was 0.15 cm².

With respect to the above capacitor element, impedance was measured in a range of 1 MHz to 1 Hz. This measurement was conducted in a condition of room temperature and atmosphere.

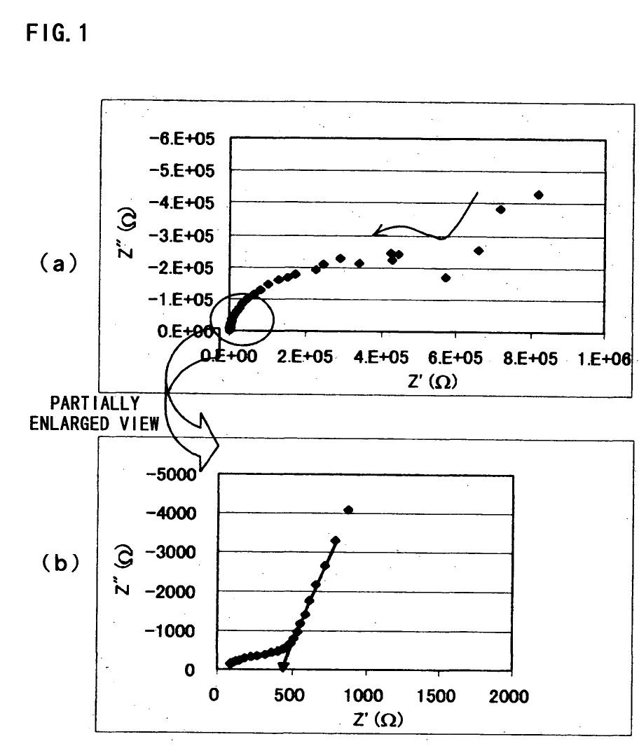

FIG. 1(a) shows the complex impedance plots measured and FIG. 1(b) is an enlarged view thereof.

As is apparent from FIG. 1, the baked silicon compound film obtained in a way described above exhibits a typical behavior of an electrolyte and is verified to be a solid electrolyte.

Further, the resistance of the thin film after baking was 470 Ω. In addition, σ=6×10⁻⁷ S/cm.

In accordance with the present invention, a novel solid electrolyte using the silicon compound film can be attained.

What is claimed is:

1. A solid electrolyte, wherein the solid electrolyte is formed by baking a thin film in which a silicon compound contains a metal salt compound.

2. The solid electrolyte according to claim 1, wherein said metal salt compound is a lithium salt compound.

3. The solid electrolyte according to claim 1, wherein said thin film contains at least either of a polysilane which is soluble in organic solvent or a silicone compound, as a silicon compound.

4. The solid electrolyte according to claim 1, wherein said silicone compound has a structure represented by the following general formula (1) 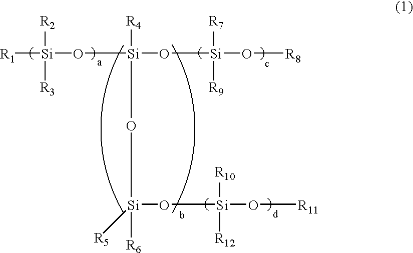
wherein R₁ to R₁₂ are groups selected from the group consisting of aliphatic hydrocarbon groups containing 1 to 10 carbon atoms, for a part of which a halogen group or a glycidyloxy group may substitutes, aromatic hydrocarbon groups containing 6 to 12 carbon atoms and alkoxy groups containing 1 to 8 carbon atoms and may be identical with or different from one another, and a, b, c and d are integers including 0 and satisfy a relationship of a+b+c+d≧1.

5. The solid electrolyte according to claim 1, wherein said thin film contains at least one of peroxide and benzophenon derivative.

6. The solid electrolyte according to claim 5, wherein said benzophenon derivative has a benzophenon skeleton represented by the following formula (2).

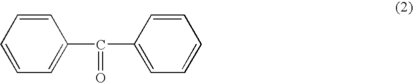

7. The solid electrolyte according to claim 5, wherein said peroxide has at least one or more linkages represented by —C(═O)—O—O— in the molecular structure.

8. The solid electrolyte according to claim 1, wherein said solid electrolyte was prepared by baking at a temperature of 400° C. or higher.

9. A capacitor element, wherein said capacitor element has a structure in which the solid electrolyte according to claim 1 is sandwiched between a pair of electrodes.
